(19) United States
(12) Patent Application Publication
(10) Pub. No.: US 2013/0054817 A1
(43) Pub. Date: Feb. 28, 2013

(54) DISAGGREGATED SERVER LOAD BALANCING

(71) Applicants: Daniel G. Moen, Fremont, CA (US); Jason D. Notari, Pleasanton, CA (US)

(72) Inventors: Daniel G. Moen, Fremont, CA (US); Jason D. Notari, Pleasanton, CA (US)

(73) Assignee: CISCO TECHNOLOGY, INC., San Jose, CA (US)

(21) Appl. No.: 13/220,591

(22) Filed: Aug. 29, 2011

(51) Int. Cl. G06F 15/16

(52) U.S. Cl. 709/227

(57) ABSTRACT

Various systems, processes, and products may be used to provide disaggregated server load balancing. In particular implementations, systems, processes, and products may include the ability to receive a connection request at an application delivery controller from a client device, analyze the connection request to determine one of a plurality of application delivery controller agents to handle the connection request, send the connection request to the determined application delivery controller agent, and analyze the connection at the determined application delivery controller agent request to determine an application server to handle the connection request.

### TECHNICAL FIELD

The present invention relates generally to server systems, and more specifically to server load balancing.

### BACKGROUND

Web-sites that receive relatively large amounts of traffic (e.g., connection requests) typically have a number of servers. For example, busy commercial web-sites may have tens, or even hundreds, of servers. Web-sites having a number of servers often include a server load balancer that is located between the external communication network and the servers. The server load balancer is used, among other things, to distribute traffic between the application servers. For example, the server load balancer may distribute traffic between the servers based on how busy each server is.

### BRIEF DESCRIPTION OF THE DRAWINGS

FIG. 1 is a block diagram illustrating an example system for disaggregated server load balancing.

FIG. 2 is a block diagram illustrating another example system for disaggregated server load balancing.

FIG. 3 is a flowchart illustrating an example process for disaggregated server load balancing.

FIG. 4 is a flowchart illustrating another example process for disaggregated server load balancing.

FIG. 5 is a flowchart illustrating an additional example process for disaggregated server load balancing.

FIG. 6 is a flowchart illustrating a further example process for disaggregated server load balancing.

FIG. 7 is a flowchart illustrating another example process for disaggregated server load balancing.

FIG. 8 is a flowchart illustrating an additional example process for disaggregated server load balancing.

FIG. 9 is a flowchart illustrating a further example process for disaggregated server load balancing.

FIG. 10 is a flowchart illustrating another example process for disaggregated server load balancing.

FIG. 11 is a block diagram illustrating an example computer system for disaggregated server load balancing.

### DETAILED DESCRIPTION

In one general implementation, a procedure for disaggregated server load balancing may include the ability to receive a connection request at an application delivery controller from a client device, analyze the connection request to determine one of a plurality of application delivery controller agents to handle the connection request, and send the connection request to the determined application delivery controller agent. The procedure may also include the ability to analyze the connection at the determined application delivery controller agent request to determine an application server to handle the connection request.

Load balancing for servers may be disaggregated to improve performance. In some implementations, the load balancing functions may be split between an application delivery controller and an agent running on a system that hosts one or more application servers.

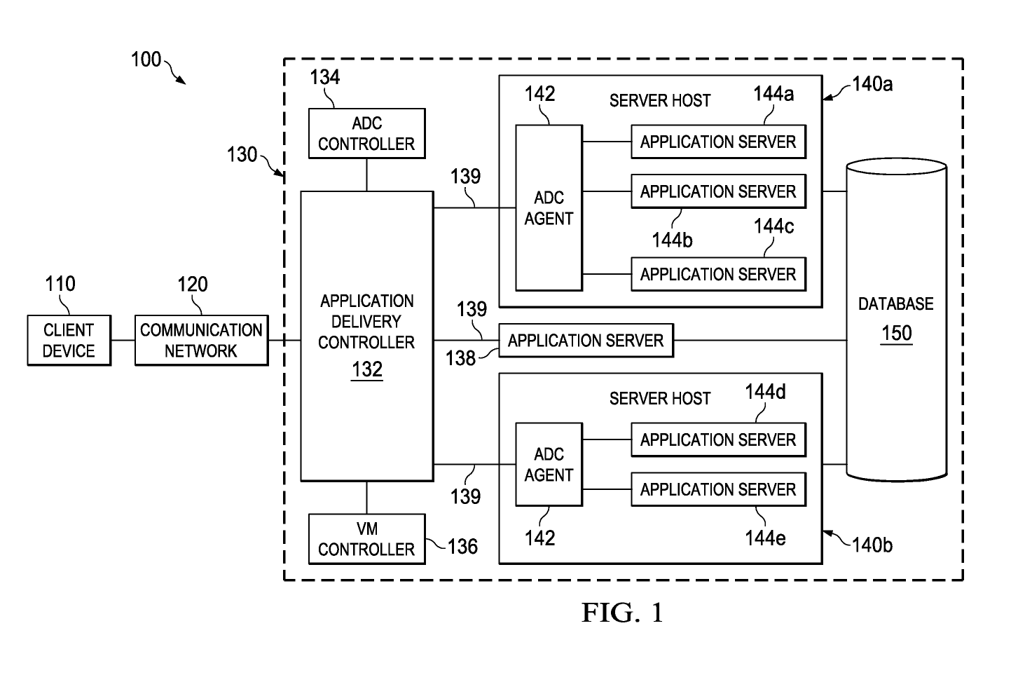

FIG. 1 illustrates an example system 100 for disaggregated server load balancing. In general, system 100 includes a client device 110 that communicates through a communication network 120 to a server system 130. In particular implementations, client device 110 and server system 130 may establish a client-server relationship using TCP/IP protocols through communication network 130, which may include the Internet.

Client device 110 may be any device that makes requests of and receives responses from a server system. For example, client device 110 may be a personal computer, a tablet computer, a workstation, or a smart phone. Client device 110 may communicate with communication network 120 through a wired or wireless connection. In particular implementations, client device 110, under the control of an operator, may issue hyper-text transfer protocol (HTTP) requests to a server system. Other examples of message-related protocols that may issue requests include Transfer Control Protocol (TCP), User Datagram Protocol (UDP), File Transfer Protocol (FTP), Domain Name System (DNS), Remote Desktop Protocol (RDP), Session Initiation Protocol (SIP), and Secure Socket Layer (SSL).

Communication network 120 may be any collection of devices that can convey data between a client device and a server system. For example, communication network 120 may include one or more links, switches, routers, bridges, and gateways. Furthermore, various parts of communication network 120 may operate according to wired (e.g., cable, fiber-optic, etc.) and/or wireless (e.g., cellular telephone, microwave, etc.) techniques.

Server system 130 includes an application delivery controller 132, a controller 134 for the application delivery controller, a virtual machine (VM) controller 136, an application server 138, and server hosts 140. Each of server hosts 140 includes an application delivery controller (ADC) agent 142 and one or more application servers 144.

In this example, server hosts 140 are servers that implement ADC agents 142 and application servers 144 as virtual machines. Each time an additional machine (e.g., application server) is needed, a server host 140 may assign a portion of its resources and create an instance of the needed machine. The instance may, for example, be a virtual copy of an already existing machine. The operating systems of server hosts 140 may be able to run multiple operating systems. VM controller 136 may provide the relationship between the virtual machines.

Application server 138 may be a physical server that stands alone from application servers 144 running on server hosts 140. Thus, application server 138 may be a physical server running separate from the application server 144 virtual machines.

Application delivery controller 132 is coupled to application server 138 and host servers 140 by links 139. Links 139 may, for example, include one or more wireless and/or wireless links.

ADC agents 142 may serve as supplementary load balancers to application delivery controller 132 while using the resources of server hosts 140. ADC agents 142 may have the full functionality of application delivery controller 132 or part of its functionality. In particular implementations, ADC agents 142 may perform operations that involve examining or processing message payload data (e.g., SSL, compression, scripting, etc.) to perform the load balancing functions.

In certain implementations, ADC agents 142 may also provide additional services to the applications running on application servers 144. For example, services such as caching, compression, and application acceleration could be provided by an ADC agent. While these could be handled by the applications directly, they typically require additional developer knowledge, and the ADC agents can provide a scalable location (while not at a single point of failure) to perform this functionality. Moreover, using the ADC agents could avoid complex development, operational expense (OPEX) (or maintenance cost), and/or a latency inducing extra hop.

When client device 110 issues a connection request (e.g., to initiate a session or as part of a session), the request traverses communication network 120 and is received at application delivery controller 132, which makes a determination regarding the handling of the request. For example, if the connection request is for a new session, the application delivery controller may determine whether the connection request should be handled by application server 138 or one of application servers 144. In making this determination, application delivery controller 132 may, for example, examine the lower-level data used in the physical routing data of the connection request (e.g., Internet Protocol (IP) address, Media Access Control (MAC) address, port number, etc.). In particular implementations, the data may correspond to that in Layers 2-4 of the Open Systems Interconnect (OSI) model developed by the International Organization for Standardization (ISO).

If the application delivery controller determines that it should handle the request, the application delivery controller may determine an application server (e.g., application server 138) for the request. The application server may, for example, be chosen based on current load. After the application server is determined, application delivery controller 132 may pass the connection request to the application server.

If, however, the application delivery controller determines that one of application servers 144 should handle the connection request, the connection request is passed to the appropriate ADC agent. The appropriate ADC agent may then further examine the connection request.

The appropriate ADC agent may examine the connection request to determine whether it should handle the connection request. To make this determination, the ADC agent may, for example, examine data regarding the data in the connection request (e.g., SSL, authentication, authorization, and accounting (AAA), and possibly even the data itself). For instance, the ADC agent may use SSL techniques to examine the payload contents of the connection request and make a determination based on that data. In particular implementations, the data examined may correspond to that in Layers 5-7 of the OSI model.

If the ADC agent should handle the connection request, the ADC agent may select an associated application server 144 for the request. The application server may, for example, be chosen based on current load or persistence. After an associated application server is selected, the ADC agent may pass the connection request to the selected application server.

If, however, the selected ADC agent should not handle the connection request, the ADC agent may initiate a process to redirect the connection request to an ADC agent associated with the server that should handle the connection request. An ADC agent may, for example, not handle a connection request due to persistence or particular data operations not being available on the local application servers. For instance, load balancing decisions could be based on image URLs, which could be available at the L7 layer and serviced from a special server farm. The selected ADC agent may, for example, determine the application server associated with the connection request and, possibly, the ADC agent associated with the application server. The ADC agent may also contact the application delivery controller to redirect the connection request to the appropriate application server/ADC agent. This process will be discussed in more detail below.

Application servers typically generate a response (e.g., a file transfer, a web page transfer, etc.) to connection requests. As part of this, the application servers may access data from a database 150.

When an application server 144 has generated a response, it may pass the response to the associated ADC agent 142. The associated ADC agent may then begin the process of sending the response to the client device. For example, the ADC agent may send the response back to application delivery controller 132 for delivery to client device 110 or send the response back to the client device without going through the application delivery controller (e.g., by direct server return (DSR)), more detailed examples of which will be discussed below.

Application servers 144 may be configured and cloned using resident configuration and software. For example, the servers may be created, and the addresses (e.g., DNS and VIP) assigned. The application delivery controller may also be notified when instances are added (or deleted). For example, VMware tools from VMware of Palo Alto, Calif. may be used by to get a variety of data about machines.

In particular implementations, an ADC agent 142 may send the address of client device 110 to an associated application server 144 so that it may understand from which client device a connection request originates. To accomplish this, the ADC agents may switch the source address of a connection request from application delivery controller 132 to that of client device 110. Thus, the traffic may, for example, look like it comes from the client devices.

The client device address may be unknown to the ADC agents from the connection request messaging used between the ADC agents and application delivery controller 132. The ADC agents may, however, still receive the client device's address from the application delivery controller. As one example, application deliver controller 132 may send the client device address through IP tunneling (e.g., at the L-4 layer) or a session identification packet. Thus, the address does not have to be sent through a fully encapsulated tunnel. The receiving ADC agent 142 may then use the client address when communicating with the appropriate application server.

Table 1 illustrates an example address translation for this scenario. In this example, the ADC agent and the application server share the same address because the ADC agent is handling the traffic going into and out of the application server, although some of the traffic is simply passed through.

TABLE 1

| Hop | Description | Source IP | Destination IP |
|---|---|---|---|
| 1 | Client Device to ADC | 161.1.134 | 64.4.5.81 |
| 2 | ADC to ADC Agent | 64.4.5.81 | 10.1.1.10 |
| 3 | ADC Agent to App Server | 161.1.134 | 10.1.1.10 |

Thus, the client address may be provided to the application server while still allowing intermediate source network address translation (NAT). This functionality could, for example, be accomplished without additional configuration on the application server or underlying operating system since the ADC agent can itself can do address fix-ups to flows passed down from the application delivery controller.

These implementations also provide multiple ways for ADC agents 142 to send responsive data back to client device 110. In certain scenarios, for example, the ADC agents may send the responsive data to application delivery controller 132 for delivery to client device 110. In doing so, the ADC agents may send the address of client device 110 to application delivery controller 132. For example, the ADC agent may send the address through IP tunneling (e.g., at the L-4 layer). The application delivery controller may then use the client address when communicating with client device 110.

Table 2 illustrates an example address translation for this scenario. This scenario may allow Secure Socket Layer (SSL) termination at the ADC agent.

TABLE 2

| Hop | Description | Source IP | Destination IP |
|---|---|---|---|
| 1 | Client Device to ADC | 161.1.134 | 64.4.5.81 |
| 2 | ADC to ADC Agent | 64.4.5.81 | 10.1.1.10 |
| 3 | ADC Agent to App Server | 161.1.134 | 10.1.1.10 |
| 4 | App Server to DB | 10.1.1.10 | 11.1.1.11 |
| 5 | DB to App Server | 11.1.1.11 | 10.1.1.10 |
| 6 | App Server to ADC Agent | 10.1.1.10 | 161.1.134 |
| 7 | ADC Agent to ADC | 10.1.1.10 | 64.4.5.81 |
| 8 | ADC to Client Device | 64.4.5.81 | 161.1.134 |

In other scenarios, the ADC agents may send the responsive data directly to client device 110. In doing so, the ADC agents may use the address of application delivery controller 132. Table 3 illustrates an example address translation for this scenario. This scenario provides the benefit of significantly reducing traffic through the application delivery controller 132 (e.g., by 60%). For instance, while HTTP requests typically are small, HTTP responses are usually large.

TABLE 3

| Hop | Description | Source IP | Destination IP |
|---|---|---|---|
| 1 | Client Device to ADC | 161.1.134 | 64.4.5.81 |
| 2 | ADC to ADC Agent | 64.4.5.81 | 10.1.1.10 |
| 3 | ADC Agent to App Server | 161.1.134 | 10.1.1.10 |
| 4 | App Server to DB | 10.1.1.10 | 11.1.1.11 |
| 5 | DB to App Server | 11.1.1.11 | 10.1.1.10 |
| 6 | App Server to ADC Agent | 10.1.1.10 | 161.1.134 |
| 7 | ADC Agent to Client Device | 64.4.5.81 | 161.1.134 |

There are a variety of options for ADC agent installation. The ADC agent may, for example, be installed by centralized deployment and configuration, as well as deployment via third party software. After installation, the ADC agent may be configured with the following information:

Unique machine identification

Hosted applications

Application URI

Application Health URI

Application type

Application zone

Data IP(s)

Specific requirements (e.g., persistence and other options).

Once the ADC agent is configured, it may, for example, broadcast a wake-up message via a discovery protocol (e.g., Cisco Discovery Protocol (CDP)) to discover the address of the local application delivery controller. In other implementations, it may be possible for the ADC agent to be configured with the address (e.g., DNS name) of the application delivery controller. After determining the address, the ADC agent may open a control channel to the application delivery controller (e.g., via TCP) and publish the application configuration information.

Automatic application provisioning may also be provided. For example, the application DNS name may be looked for from the uniform resource identifier (URI). If a match is found, it may be checked against the local configuration. If a match is found, a server configuration may be added to the configuration approval queue, from which it could be auto-approved. If no match is found, an ambiguous situation exists. This could be a new site requiring global server load balancing (GSLB) or a backup site handled by another application delivery controller. This situation could be solved by the use of rules or user input (perhaps after a query). In particular implementations, this can be expanded with site-to-site application delivery controller coordination. If no match is found, a new DNS entry and VIP (from a pool) may be generated along with server farms (pools), and servers will be configured. This configuration will be added to the approval queue, from which it could be auto-approved.

As an example of this, an application server could be running a type of software that varies depending on time (e.g., quarterly financial reporting software). This software may only require limited, or no, resources at certain points in time but large amounts of resources at others. As the software requires heavier use, various parts of the software may become active. The application server may publish the software to the application through the application delivery controller and join the application. Thus, the application resources may be dynamically grown and shrunk.

Since the ADC agent is on the host system and each host system would probably only host a relatively small number of servers, it may be possible to internally probe within the system (e.g., from the ADC agents to the application servers) at a relatively high rate, which may be difficult to do for a single entity polling a large number (e.g., thousands) of servers. This internal polling need not have an impact on the application delivery controller since periodic reachability (e.g., “ping”) and heartbeat (e.g., “all okay”) messages can be sent at a very slow rate, and in application failure situations a message (e.g., “fail”) can be propagated up immediately. In situations where it is not advisable to do high rate application polling, it would also be possible to do direct process monitoring or in-band health checks.

An application server may provide a natural place to conduct application maintenance, and the ADC agent set may provide a natural place for delegated Activation and Suspension without the need for complex role-based access control (RBAC) on a central management system. A user with the ability to make changes to the server software could also be able to make operational changes within the ADC agent itself (e.g., interacting with the ADC agent to shut it down), without the need for another tool or user silo interaction.

Virtualization may give server operators the ability to clone machines at will, and a cloned ADC agent may present itself to the network as yet another instance of the same application, allowing automatic scale out of applications since the applications would register themselves.

Users of the ADC agent may have visibility into the various ADC devices that are directing traffic to it. For example, if an application server is providing web-sites for two different application delivery controllers, the user may have visibility into both application delivery controllers. They may also be able to view stats on server farm peers to allow informed decisions before doing maintenance actions. Visibility may also be had into multiple application delivery controllers as well as the states of the various services being load balanced. In certain implementations, the ADC agent could be installed on VMs and physical machines to provide a simplified way in order to see these benefits.

System 100 provides a variety of features. For example, it allows a server system to operate in a faster manner because one or more functions of the application delivery controller 132 may be distributed to ADC agents 142 in server hosts 140, thereby relieving the burden on a central control point. System 100 also provides a reduction of risk by placing the functionality onto less constrained systems that are handling fewer connections. Moreover, this allows features to be met with less robustness than if those same features are placed in a central location.

System 100 also provides the ability to rapidly, and even automatically, scale up the server system since the ADC agents and application servers may be readily replicated. Thus, system 100 may operate in an environmentally friendly manner since quick scale-up and scale-down may be based on actual connection requirements.

Additionally, upgrading the application delivery controller functions may be easier because the functions may be incorporated into the ADC agents as opposed to the application delivery controller itself, which can take a long time to initialize and optimize. An application delivery controller is typically fast, robust, and reliable, often coordinating millions of concurrent client devices on one side and thousands of different servers on the other. But each new feature present on an application delivery controller may slow it down and provide an opportunity for new bugs in an area that can least afford issues. System 100 may also avoid latency issues, which may be associated with adding additional tiers and clustering, because connections do not have to be terminated and buffered up to the application layer (Layer 7). Moreover, additional network topology complexity that occurs as more hops are added may be avoided. There is also an opportunity to enable faster service roll out, and more stable services via faster error detection and fail over (e.g., due to high polling frequencies).

Additionally, using the ADC agents allows current and future server load balancing functionality to be placed at the application delivery controller or on the server host themselves. It also allows for at least a partial disaggregation of application delivery configuration onto the server host itself. This does not, however, mean that top down configuration or policy enforcement cannot be done. The application delivery controller may still be the natural central control point.

It may also be possible to open up a stream interface for additional third party software or custom code to run within the ADC agent itself ADC agent software would still need to be reliable, but not to the degree required at a central location (e.g., four nines rather than five)

Although FIG. 1 illustrates an implementation of the ADC agents in a VM environment, other environments may also be used. For example, the ADC agents could be implemented in an operating system (OS) environment. In an OS environment, for example, each ADC agent could be running inside an OS for an application server. Thus, each ADC agent may operate in a different operating system (e.g., Windows, Linux, or Unix).

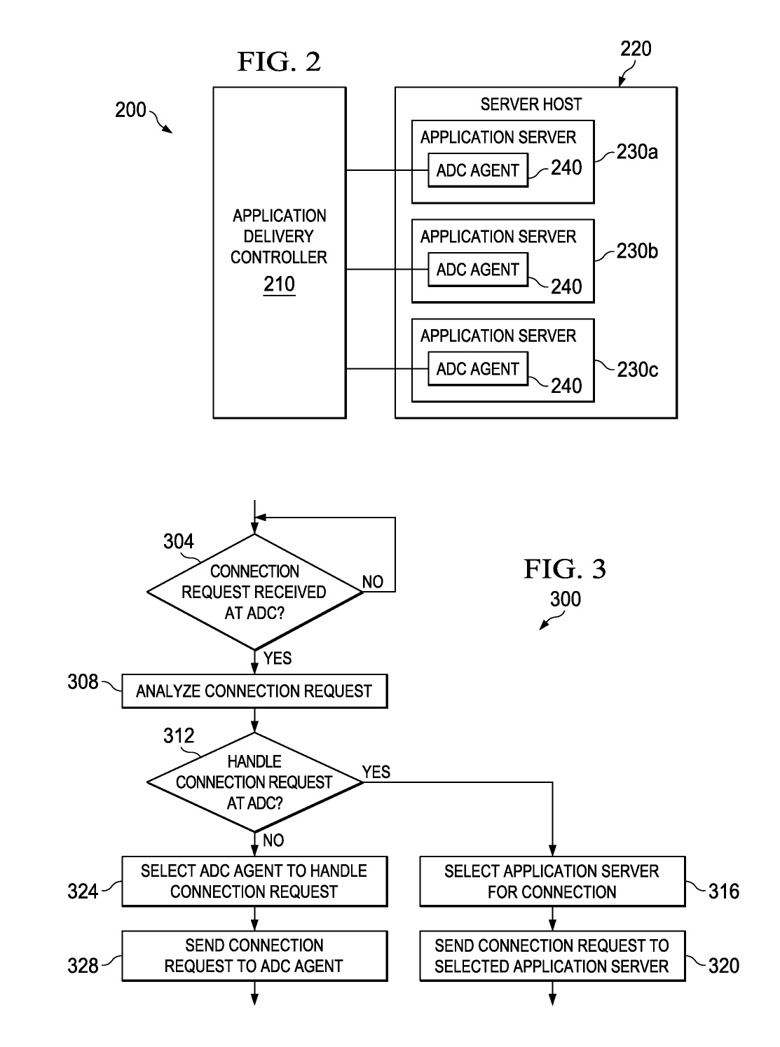

FIG. 2 illustrates an example OS-based system 200 for disaggregated server load balancing. System 200 includes an application delivery controller 210 and a server host 220. Server host 220 includes a number of application servers 230, each of which includes an ADC agent 240.

These ADC agents may be installed, configured, published, and provisioned by techniques similar to those discussed previously. Furthermore, the ADC agents may be cloned at will, and a cloned ADC agent may present itself to the network as yet another instance of the same application, allowing automatic scale out of applications since the applications would register themselves. Health monitoring may be performed by internal polling, direct process monitoring, or in-band health checks.

An application server may also provide a natural place to conduct application maintenance, and the ADC agent set may provide a natural place for delegated Activation and Suspension without the need for complex RBAC on a central management system. A user with the ability to make changes to the server software could also be able to make operational changes within the ADC agent itself (e.g., interacting with the ADC agent to shut it down), without the need for another tool or user silo interaction. Users of the ADC agent may also have visibility into the various ADC devices that are directing traffic to it. (e.g., application delivery controllers and server farm peers).

An OS-based implementation may also provide enhanced information for load balancing. For example, the ADC agent may provide a natural place to provide detailed information to the application delivery controller about the application server hosting the application, including: CPU, memory, disk utilization, and network bandwidth. This can be aggregated with information throughout the server farm in order to automatically distribute load in accordance with machine capabilities. Proper connection limiting could be done at the ADC agent level no matter the number of application delivery controllers configured to pass traffic to the ADC agent.

As another example, the ADC agents could be implemented in a hypervisor environment, which could be topologically similar to the OS-based environment. In this case, a hypervisor element, such as a virtual switch (e.g., the N1000v available from Cisco Systems Inc. of San Jose, Calif.), could be augmented with the ADC agent. For example, a virtual switch may provide L2-L3 functions, and the ADC agent could operate as an L4-L7 extension of the switch. The ADC agent could operate in the hypervisor where the virtual switch is running. This implementation may be relatively easier to implement (e.g., less development and testing) because there may be fewer combinations than, for example, an OS-based implementation. It may also be beneficial on the deployment side because it could require fewer total installations (one per host rather than one per virtual machine).

In a hypervisor environment, the ADC agent could respond to an Internet Control Message Protocol (ICMP) like ping originated by the application delivery controller in order to make the application delivery controller aware of its existence. This ping could be directed at the virtual machine (or real server), intercepted, and responded to by the ADC agent if it exists.

If the ADC agent is located on the server side, it may not need to ask for topology, as it can be determined. With knowledge about both sides of a connection, it is possible to determine the topology based on interface configuration, IP addresses, Address Resolution Protocol (ARP) entries, and routes.

Other mechanisms that could be used to determine topology include:
Injection of traffic to the data interface (Health Monitoring as well as client spoofed data);
Evaluation of address resolution (ARP) tables and route tables on the application server as well as the application delivery controller;
Creation and testing of a pseudo L3 tunnel between the ADC agent and the application delivery controller; and
Source network address translation (NAT) failing the above.
   Other options could also include a full IP tunnel using encap/decap. The ADC agent could possibly also behave like a Service Insertion Architecture (SIA) proxy for the end service, which would allow upstream devices that communicate with the service to view the service as being SIA aware.

Thus, through various implementations, the server systems may provide bottom up automatic DNS and VIP creation and automatic update of the application delivery controller as new application servers are added. Additionally, the server systems may provide automatic weighted traffic balancing and application delivery controller offload of value-add services without introduction of latency. Furthermore, the server systems may provide automatic topology discovery and additional topology options with little to no configuration needed.

FIG. 3 illustrates a process 300 for disaggregated server load balancing. Process 300 may, for example, be implemented by a server system such as server system 130.

Process 300 calls for determining, for example, at an application delivery controller, whether a connection request has been received (operation 304). A connection request may, for example, be a request for a TCP/IP session. Process 300 may make this determination on any appropriate basis (e.g., time or event). If a connection request has not been received, process 300 calls for continuing to wait for a connection request.

Once a connection request has been received at an application delivery controller, process 300 calls for analyzing the connection request (operation 308). The connection request may, for example, be analyzed to determine a proper application server to which to route the request. For instance, if the connection request is part of a pre-existing session, the connection request may be routed to a predetermined application server. As another example, if the connection request is for a new session, an appropriate application server can be selected to handle the connection request. Analyzing the connection request can, for example, include examining the lower-level data used in the physical routing data used for the connection request (e.g., IP Address, Media Access Control (MAC) address, port number, etc.).

Process 300 also calls for determining whether the application delivery controller will handle the connection request (operation 312). The application delivery controller may, for example, handle the connection request if it is destined for an application server that is managed directly by the application delivery controller. If the application delivery controller will handle the connection request, process 300 calls for selecting an application server to handle the connection request (operation 316) and sending the connection request to the selected application server (operation 320). Process 300 is then at an end (e.g., it may stop or return to determine whether another connection request has been received).

If, however, the application delivery controller will not handle the connection request, process 300 calls for selecting an ADC agent to handle the connection request (operation 324). In selecting an ADC agent, the application delivery controller may, for instance, take into account a number of factors, such as determining the load of the ADC agents, the associated application servers, and the routing data. The connection request may then be sent to the selected ADC agent (operation 328). The connection request may, for example, be sent to the agent through an IP tunnel. Process 300 is then at an end (e.g., it may stop or return to determine whether another connection request has been received).

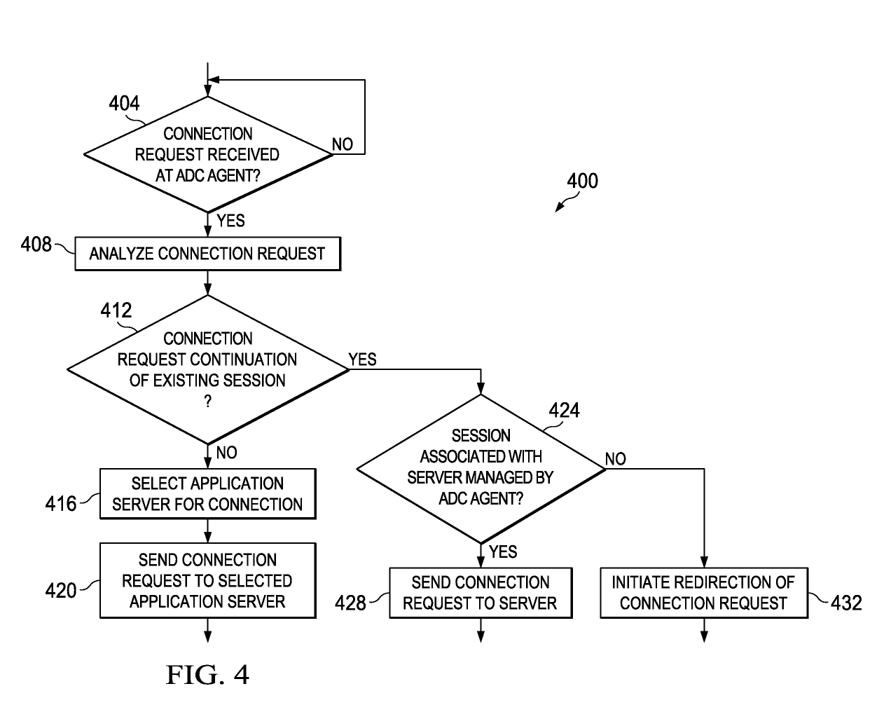

FIG. 4 illustrates another process 400 for disaggregated server load balancing. Process 400 may, for example, be implemented by a server system such as server system 130.

Process 400 calls for determining at an ADC agent whether a connection request has been received (operation 404). A connection request may, for example, be a request for a TCP/IP session and be received from an application delivery controller. If a connection request has not been received, process 400 calls for continuing to wait for a connection request.

Once a connection request has been received at an ADC agent, process 400 calls for analyzing the connection request (operation 408). The connection request may, for example, be analyzed to determine a proper application server to which to send the request or whether the connection request should be redirected to an application server not managed by the ADC agent. Analyzing the connection request may, for example, include examining the lower-level data used in the physical routing data used for the connection request (e.g., IP Address, Media Access Control (MAC) address, port number, etc.) and higher-level services. For example, the connection request can be decrypted to analyze the payload data in the connection request, and AAA functions can be applied.

Process 400 also calls for determining whether the connection request is a continuation of an existing session (operation 412). If the connection request is not part of an existing session, process 400 calls for selecting an application server to handle the connection request (operation 416). The application server may, for example, be a virtual server located on the same machine as the ADC agent. In selecting an application server, the ADC agent may take into account a number of factors, such as determining the load of the application servers and the routing data. The connection request may then be sent to the selected application server (operation 420).

If the connection request is part of an existing session, process 400 calls for determining whether the session is associated with an application server managed by the ADC agent (operation 424). Thus, the ADC agent may determine whether it will handle the connection request. If the session is associated with an application server managed by the ADC agent, process 400 calls sending the connection request to the application server (operation 428).

If, however, the session is not associated with an application server managed by the ADC agent, process 400 also calls for initiating a redirection of the connection request (operation 432). Initiating a redirection may, for example, include identifying an application server associated with the connection request and sending a message to the application delivery controller regarding redirecting the connection request to the appropriate application server. The redirection of a connection request will be discussed in more detail below.

Processes 300 and 400 have a variety of features. For example, the processes allow the functions of an application delivery controller to be distributed between the application delivery controller and an ADC agent. Thus, the functions may be distributed between two physical systems—one hosting the application delivery controller and one hosting the ADC agent, which may allow the functions to be performed in a faster and more efficient manner.

In certain implementations, a connection request for a new session may be analyzed at an ADC agent for redirection to another ADC agent. For example, an ADC agent may initiate redirection of a connection request based on the data required (e.g., images) for the connection request.

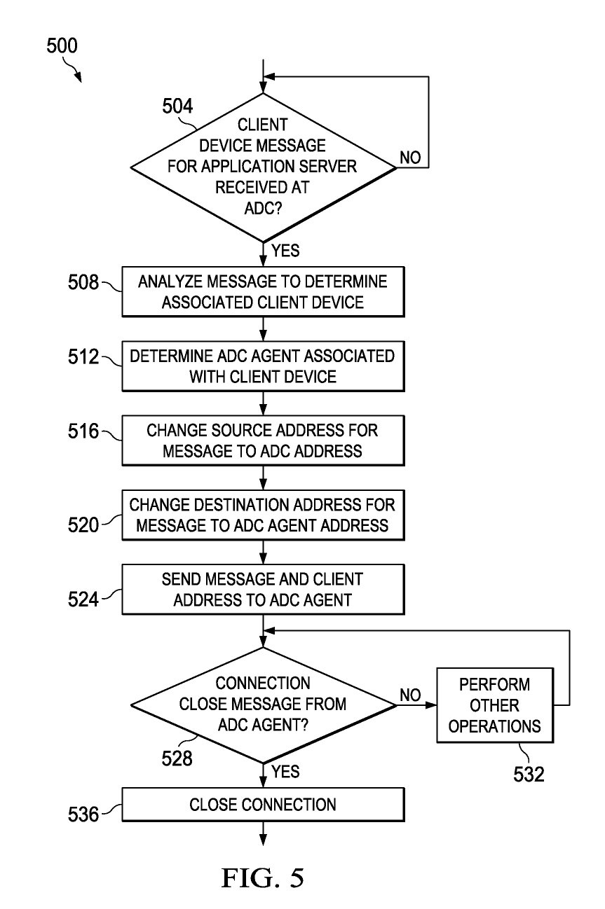

FIG. 5 illustrates another example process 500 for disaggregated server load balancing. Process 500 may, for example, be implemented by a server system like server system 130.

Process 500 begins with determining whether a message from a client device and destined for an application server has been received at an application delivery controller (operation 504). The message may, for example, be an initial message in a connection or a subsequent message in a connection. If a client device message for an application server has not been received, process 500 calls for continuing to wait for a client device message.

Once a client device message for an application server has been received, process 500 calls for analyzing the message to determine the associated client device (operation 508). The associated client device may, for example, be determined from examining a source address. Additionally, process 500 calls for determining an ADC agent associated with the client device (operation 512). If the message is a connection request, for example, the ADC agent may have to be selected. If the message is for a pre-existing connection, the ADC agent may already be selected and just need to be retrieved.

Process 500 also calls for changing the source address for the message to the application delivery controller's address (operation 516) and changing the destination address or the message to the ADC agent's address (operation 520). The application delivery controller may then send the message and the client address to the ADC agent (operation 524). The message and the client address may, for example, be sent in the same message or a different message.

Process 500 also calls for determining whether a message regarding closing of the connection associated with the message has been received from the ADC agent (operation 528). If a message regarding the closing of the connection has not been received, process 500 calls for the application delivery controller to perform other operations (operation 532). For example, the application delivery controller may handle other connection requests and messages, whether for the connection or other connections. Once a message regarding the closing of the associated connection has been received, process 500 calls for the application delivery controller to close the connection (operation 536). Closing the connection may, for example, entail the releasing of resources (e.g., memory) used to support the connection in the application delivery controller.

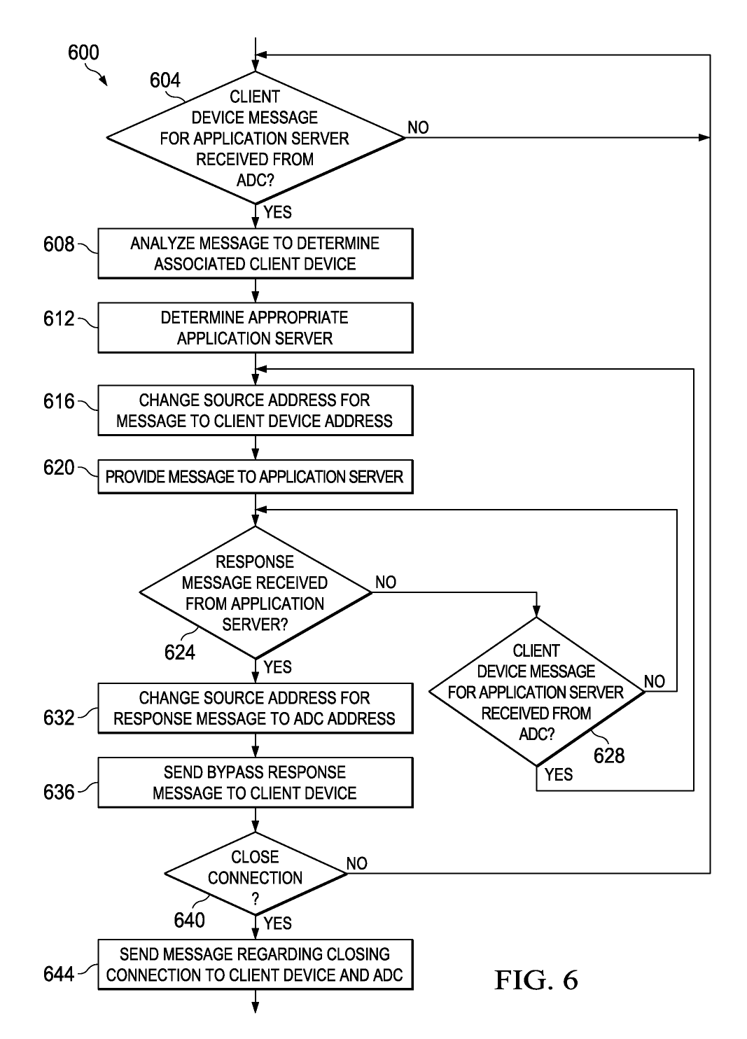

FIG. 6 illustrates another example process 600 for disaggregated server load balancing. Process 600 may, for example, be implemented by a server system like server system 130.

Process 600 calls for determining whether a message from a client device and destined for an application server has been received from an application delivery controller (operation 604). The client device message may, for example, be an initial message in a connection or a subsequent message in a connection. If a client device message for an application server has not been received, process 600 calls for continuing to wait for a client device message.

Once a client device message for an application server has been received, process 600 calls for analyzing the message to determine the associated client device (operation 608). The associated client device may, for example, be determined by examining an identifier sent from the application delivery controller. The identifier may, for instance, be an address for the client device or an identifier that is associated with the address. Additionally, process 600 calls for determining an appropriate application server for the message. If, for example, the message is the initial message in a connection, an ADC agent may select an appropriate application server based on characteristics desired for the connection (e.g., SSL, application acceleration (AA), persistence, AAA, etc.) and server loads. For instance, the ADC agent may use an identity and role-based security architecture, such as, for example, Cisco Trust Security (CTS) from Cisco Systems, Inc. of San Jose, Calif. If the message is a subsequent message for a connection, the appropriate application server may already be known to the ADC agent and just need to be retrieved.

Process 600 also calls for changing the source address for the message to the client device's address (operation 616), which may have been received previously from the application delivery controller, and providing the message to the application server (operation 620). Process 600 also calls for determining whether a response message has been received from the application server (operation 624).

If a response message has not been received, process 600 calls for checking whether another message from the client device and destined for the application server has been received (operation 628). In particular implementations, for example, multiple messages may be associated with a connection. If another client device message has been received, process 600 calls for changing the source address for the message to the client device's address (operation 616) and providing the message to the application server (operation 620). If another client device message has not been received, process 600 calls for again checking whether a response message has been received from the application server (operation 624).

Once a response message has been received from the application server, process 600 calls for changing the source address for the response message to the application delivery controller's address (operation 632) and sending the response message to the client device by bypassing the application delivery controller (operation 636). The message may, for example, be sent by direct server return techniques.

Process 600 also calls for determining whether to close the connection associated with the messages (operation 640). Determining when to close a connection may, for example, be based on: 1) the transport protocol indicating a connection is complete and no more traffic will flow (e.g., TCP RST received or TCP FIN sequence complete); 2) no traffic having been received on the connection for a pre-determined amount of time (e.g., a timeout); 3) an associated connection having been shut down for some reason (e.g., association between FTP control and data); 4) a manual connection close request having been issued by a user, specifically or in bulk (e.g., close all connections on an interface); and/or 5) an associated device resource being unavailable (e.g., interface shut down or context removed).

If the associated connection should not be closed, process 600 calls for again determining whether a client device message for the application server has been received from the application delivery controller (operation 604). If the associated connection should be closed, process 600 calls for sending a message regarding closing the connection to the client device and the application delivery controller (operation 644).

Processes 500 and 600 have a variety of features. For example, the processes allow an application delivery controller to deliver a message to an ADC agent while still communicating the client address to the ADC agent. Thus, the ADC agent may be able to deliver the client device's address to the application server. Additionally, the processes allow an ADC agent to send application server responses to the client device without going through the application delivery controller. Thus, the message load of the application delivery controller may be reduced. For example, while HTTP requests typically are small, HTTP responses are usually large.

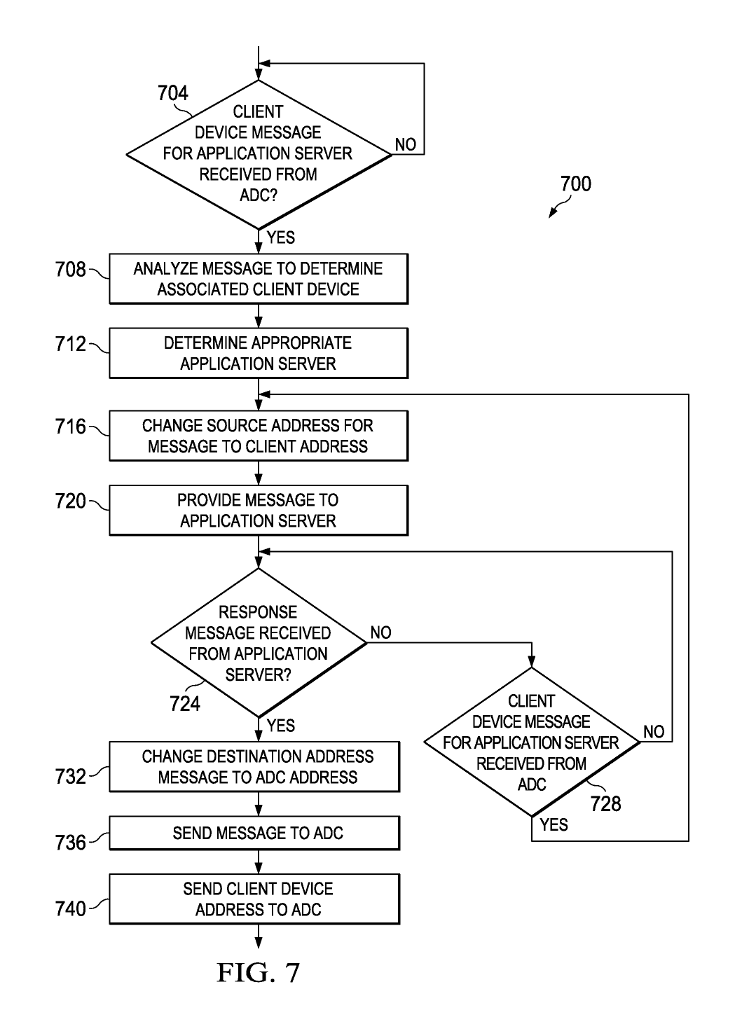

FIG. 7 illustrates another example process 700 for disaggregated server load balancing. Process 700 may, for example, be implemented by a server system like server system 130.

Process 700 calls for determining whether a message from a client device and destined for an application server has been received from an application delivery controller (operation 704). The client device message may, for example, be an initial message in a connection or a subsequent message in a connection. If a client device message for an application server has not been received, process 700 calls for continuing to wait for a client device message.

Once a client device message for an application server has been received, process 700 calls for analyzing the message to determine the associated client device (operation 708). The associated client device may, for example, be determined by examining an identifier sent from the application delivery controller. The identifier may, for example, be an address for the client device or an identifier that is associated with the address. Additionally, process 700 calls for determining an appropriate application server for the message. If, for example, the message is the initial message in a connection, the ADC agent may select an appropriate application server based on characteristics desired for the connection (e.g., SSL, application acceleration, AAA, CTS, etc.) and server loads. If the message is a subsequent message for a connection, the appropriate application server may already be known to the ADC agent and just need to be retrieved.

Process 700 also calls for changing the source address for the message to the client device's address (operation 716), which may have been received previously from the application delivery controller, and providing the message to the application server (operation 720). Additionally, process 700 calls for determining whether a response message has been received from the application server (operation 724).

If a response message has not been received, process 700 calls for checking whether another message from the client device and destined for the application server has been received (operation 728). In particular implementations, for example, multiple messages may be associated with a connection. If another client device message has been received, process 700 calls for changing the source address for the message to the client device's address (operation 716) and providing the message to the application server (operation 720). If another client device message has not been received, process 700 calls for again checking whether a response message has been received from the application server (operation 724).

Once a response message has been received from the application server, process 700 calls for changing the destination address for the response message to the application delivery controller's address (operation 732) and sending the response message to the application delivery controller (operation 736). Process 700 also calls for sending the address of the client device to the application delivery controller (operation 740). The client device address may, for example, be sent by a tunnel.

Process 700 has a variety of features. For example, the process allows an application delivery controller to deliver a message to an ADC agent while still communicating the client address to the ADC agent. Thus, the ADC agent may be able to deliver the client device's address to the application server.

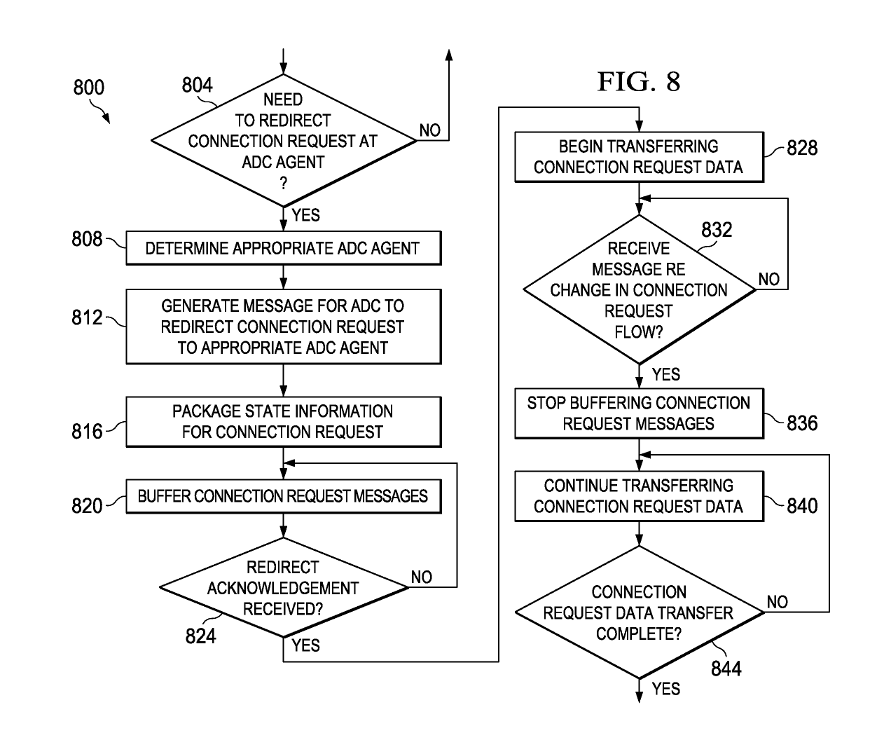

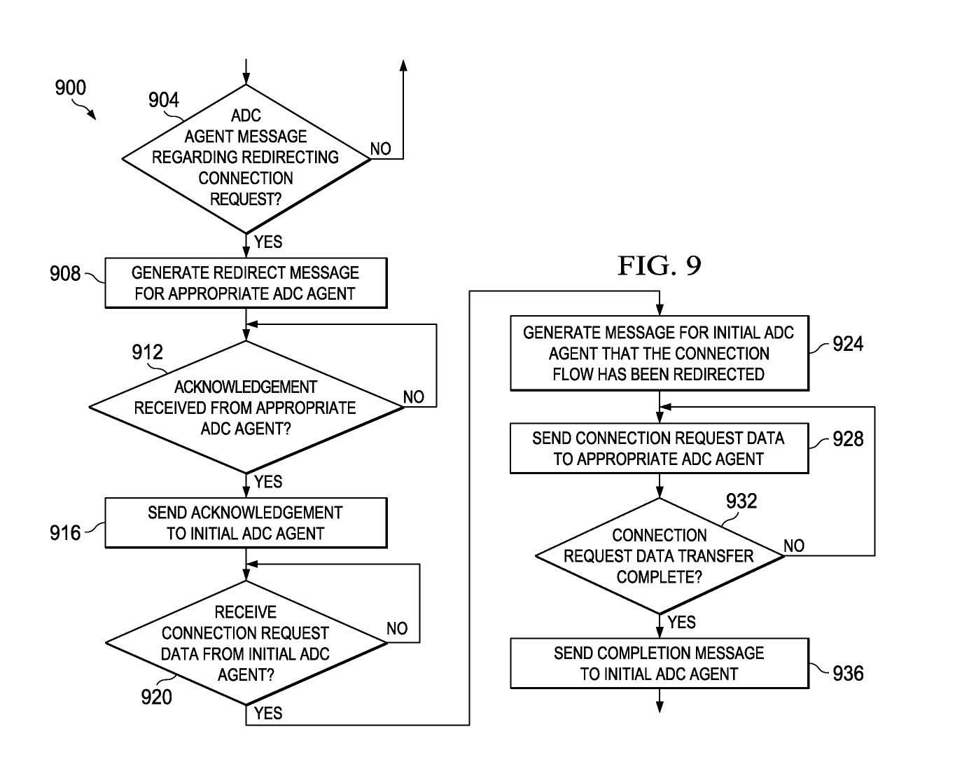

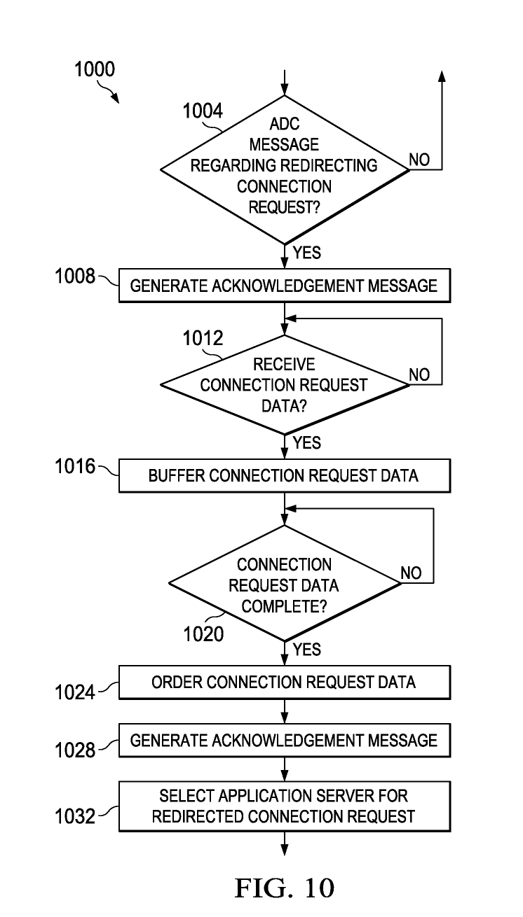

FIGS. 8-10 illustrate additional example processes for disaggregated server load balancing. In particular, FIGS. 8-10 illustrate example processes 800, 900, 1000 for redirecting a connection request from one ADC agent to another ADC agent. Processes 800, 900, 1000 may, for example, be implemented by a server system like server system 130.

Process 800 calls for determining whether a connection request at an ADC agent needs to be redirected (operation 804). A connection request may, for example, need to be redirected when it is part of a session that is being handled by an application server that is associated with another ADC agent. An ADC agent may, for instance, determine the appropriate session for the connection request by examining one or more portions of the connection request (e.g., a cookie). If a connection request does not need to be redirected, process 800 is at an end.

If, however, a connection request does need to be redirected, process 800 calls for determining an appropriate ADC agent (operation 808). The appropriate ADC agent may, for example, be determined by examining a database (distributed or global). The database may, for instance, contain a mapping between the associated session and the application server responsible for the session and a mapping between the responsible application server and the ADC agent that handles it. Process 800 calls for generating a message for the application delivery controller to redirect the connection request to the appropriate ADC agent (operation 812).

Process 800 also calls for packaging the state information for the connection request (e.g., SSL session keys, cookies, headers, etc.) (operation 816), buffering the associated connection request messages (operation 820), and checking whether a redirect acknowledgement has been received (operation 824). If a redirect acknowledgement has not been received, process 800 calls for continuing to buffer the connection request messages.

Once a redirect acknowledgement has been received, process 800 calls for beginning to transfer the connection request data (e.g., state information and associated messages) (operation 828). The connection request data may be sent to an application delivery controller, which can send the data to the appropriate ADC agent.

Process 800 also calls for determining whether a message regarding a change in connection request flow has been received (operation 832). The change in flow would typically be from the initiating ADC agent to the proper ADC agent. If a change in connection request flow has not been received, process 800 calls for waiting for the request, during which time connection request data may continue to be transferred.

Once a message regarding a change in connection request flow has been received, process 800 calls for discontinuing the buffering of connection request messages (operation 836) and continuing to transfer the connection request data (operation 840). Process 800 also calls for determining whether the connection request data transfer is complete (operation 844). If the transfer is not complete, process 800 calls for continuing to transfer the connection request data (operation 840). If, however, the transfer is complete, process 800 is at an end.

Process 900 calls for determining whether a message regarding redirecting a connection request has been received from an ADC agent (operation 904). A connection request may, for example, need to be redirected when it is part of a session that is being handled by an application server that is associated with another ADC agent than the one the application delivery controller first identified. If a message regarding redirecting a connection request has not been received, process 900 is at an end.

If, however, a message regarding redirecting a connection request has been received, process 900 calls for generating a redirect message for the appropriate ADC agent (operation 908). The message may, for example, include enough information to correctly set up the flow state to forward traffic to the appropriate application server. The appropriate ADC agent may, for example, have been specified in the message regarding redirecting the connection request.

Process 900 also calls for determining whether an acknowledgement of the redirected connection request has been received from the appropriate ADC agent (operation 912). Once an acknowledgement has been received from the appropriate ADC agent, process 900 calls for sending an acknowledgment to the initiating ADC agent (operation 916).

Process 900 further calls determining whether connection request data has been received from the initiating ADC agent (operation 920). If connection request data has not been received, process 900 calls for waiting for connection request data.

Once connection request data is received, process 900 calls for generating a message for the initiating ADC agent that the connection flow has been redirected (operation 924) and sending the connection request data to the appropriate ADC agent (operation 928).

Process 900 also calls for determining whether the connection request data transfer is complete (operation 932). Process 900 may, for example, accomplish this by receiving an acknowledgement message from the proper ADC agent. Once the connection request data transfer is complete, process 900 calls for sending a completion message to the initiating ADC agent (operation 936).

Process 1000 calls for determining whether a message regarding a redirected connection request has been received from an application delivery controller (operation 1004). A connection request may, for example, need to be redirected when it is part of a session that is being handled by an application server that is associated with another ADC agent than the one the application delivery controller first identified. If a message regarding redirecting a connection request has not been received, process 1000 is at an end.

If, however, a message regarding redirecting a connection request has been received, process 1000 calls for generating an acknowledgement message regarding the redirected connection request (operation 1008). Process 1000 also calls for determining whether connection request data (e.g., state information and messages) has been received (operation 1012). The connection request data may, for example, be from an ADC agent that originally received the connection request. If the connection request data has not been received, process 1000 calls for continuing to wait for the data.

Once the connection request data is received, process 1000 calls for buffering the connection request data (operation 1016) and determining whether the connection request data transfer is complete (operation 1020). If the connection request data transfer is not complete, process 1000 calls for waiting for the transfer to complete.

Once the connection request data transfer is complete, process 1000 calls for ordering the connection request data (operation 1024) and generating an acknowledgement message regarding the completion of the connection request data transfer (operation 1028). Process 1000 also calls for selecting an application server for the redirected connection request (operation 1032).

Processes 800, 900, 1000 illustrate the server system messaging that may take place when redirecting a connection request from one ADC agent to another ADC agent. In particular situations, a connection request may need to be redirected from an ADC agent to an application delivery controller. The messaging operations for such a redirection may be similar.

In particular implementations (e.g., when a host that is handling connections unexpectedly fails), some or all of the connection request data may have to be resent from the client device. To accomplish this, the application delivery controller may request the client device to resend some or all of the connection request data, which may be sent to the proper ADC agent by the application delivery controller.

The flowcharts and block diagrams in the figures illustrate the architecture, functionality, and operation of systems, methods, and computer program products of various implementations of the disclosure. In this regard, each block in the flowchart or block diagrams may represent a module, segment, or portion of code, which can include one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or the flowchart illustration, and combination of blocks in the block diagrams and/or flowchart illustration, can be implemented by special purpose hardware-based systems that perform the specified function or acts, or combinations of special purpose hardware and computer instructions.

As will be appreciated by one skilled in the art, aspects of the present disclosure may be implemented as a system, method, or computer program product. Accordingly, aspects of the present disclosure may take the form of an entirely hardware environment, an entirely software embodiment (including firmware, resident software, micro-code, etc.), or an implementation combining software and hardware aspects that may all generally be referred to herein as a “circuit,” “module,” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this disclosure, a computer readable storage medium may be a tangible medium that can contain or store a program for use by or in connection with an instruction execution system, apparatus, or device.

A computer readable signal medium may include a propagated data signal with computer readable program code embodied therein, for example in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any medium, including but not limited to wireless, wireline, optical fiber cable, RF, etc. or any suitable combination of the foregoing.

Computer program code for carrying out operations for aspects of the disclosure may be written in any combination of one or more programming languages such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the disclosure are described with reference to flowchart illustrations and/or block diagrams of methods, apparatus (systems), and computer program products according to implementations. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other device to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions that execute on the computer or other programmable apparatus provide processes for implementing the functions/acts specified in the flowchart and/or block diagram block or blocks.

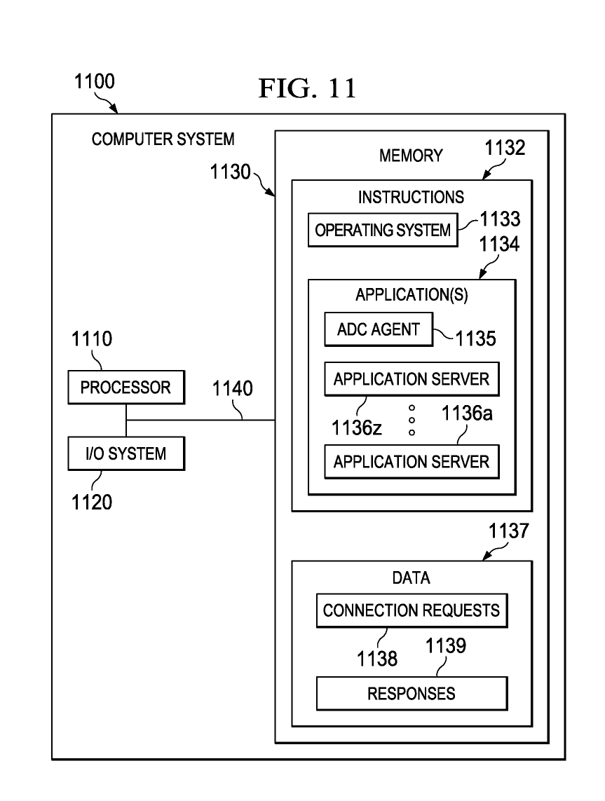

FIG. 11 illustrates an example computer system 1100 for disaggregated server load balancing. System 1100 includes a processor 1110, an input/output system 1120, and memory 1130, which are coupled together by a network 1140. As illustrated, computer system 1100 is functioning as a server host, but an application delivery controller could have similar physical configuration.

Processor 1110 typically includes a logical processing unit (e.g., an arithmetic logic unit) that processes data under the direction of program instructions (e.g., from software). For example, processor 1110 may be a microprocessor, a microcontroller, or an application specific integrated circuit. The processor may operate by reduced instruction set computer (RISC) or complex instruction set computer (CISC) principles. In general, the processor may be any device that manipulates data in a logical manner.

Input/output system 1120 may include one or more communication interfaces and/or one or more other user interfaces. A communication interface may, for instance, be a network interface card (whether wireless or wireless) or a modem. A user interface could, for instance, be a user input device (e.g., a keyboard, a keypad, a touchpad, a stylus, or a microphone) or a user output device (e.g., a monitor, a display, or a speaker). In general, system 1120 may be any combination of devices by which a computer system can receive and output data.

Memory 1130 may, for example, include random access memory (RAM), read-only memory (ROM), flash memory, and/or disc memory. Various items may be stored in different portions of the memory at various times. Memory 1130, in general, may be any combination of devices for storing data.

Memory 1130 includes instructions 1132 and data 1137. Instructions 1132 include an operating system 1133 (e.g., Windows, Linux, or Unix) and applications 1134, which include an ADC agent 1135 and application servers 136. Data 1137 includes connection request data 1138 and response data 1139.

Network 1140 is responsible for communicating data between processor 1110, input/output system 1120, and memory 1130. Network 1140 may, for example, include a number of different types of busses (e.g., serial and parallel).

The terminology used herein is for the purpose of describing particular implementations only and is not intended to be limiting. As used herein, the singular form “a”, “an”, and “the” are intended to include the plural forms as well, unless the context clearly indicates otherwise. It will be further understood that the terms “comprises” and/or “comprising,” when used in the this specification, specify the presence of stated features, integers, steps, operations, elements, and/or components, but do not preclude the presence or addition of one or more other features, integers, steps, operations, elements, components, and/or groups therefore.

The corresponding structure, materials, acts, and equivalents of all means or steps plus function elements in the claims below are intended to include any structure, material, or act for performing the function in combination with other claimed elements as specifically claimed. The description of the present implementations has been presented for purposes of illustration and description, but is not intended to be exhaustive or limited to the implementations in the form disclosed. Many modifications and variations will be apparent to those of ordinary skill in the art without departing from the scope and spirit of the disclosure. The implementations were chosen and described in order to explain the principles of the disclosure and the practical application and to enable others or ordinary skill in the art to understand the disclosure for various implementations with various modifications as are suited to the particular use contemplated.

A number of implementations have been described for disaggregated server load balancing, and several others have been mentioned or suggested. Moreover, those skilled in the art will readily recognize that a variety of additions, deletions, modifications, and substitutions may be made to these implementations while still achieving disaggregated server load balancing. Thus, the scope of the protected subject matter should be judged based on the following claims, which may capture one or more aspects of one or more implementations.

1. A system comprising:
an application delivery controller adapted to receive a connection request from a client device, analyze the connection request to determine an application delivery controller agent to handle the connection request, and send the connection request to the determined application delivery controller agent; and
a plurality of application delivery controller agents adapted to receive a connection request from the application delivery controller and further analyze the connection request to determine an application server to handle the connection request.

2. The system of claim 1, wherein the application delivery controller analyzes routing data associated with the connection request to determine an application delivery controller agent to handle the connection request, and the application delivery controller agent analyzes the payload contents of the connection request to determine an application server to handle the connection request.

3. The system of claim 1, wherein the application delivery controller is adapted to handle a connection request without the assistance of the application delivery controller agents.

4. The system of claim 1, wherein an application delivery controller agent is located on a system hosting multiple application servers.

5. The system of claim 1, wherein the application delivery controller is adapted to send the address for a client device associated with a connection request to the handling application delivery controller agent, and the handling application delivery controller agent is adapted to use the client device address as the source address when providing connection request to the determined application server.

6. The system of claim 5, wherein the handling application delivery controller agent is adapted to send the address for a client device associated with a response to a connection request to the application delivery controller, and the application delivery controller is adapted to use the client device address in sending the response to the client device.

7. The system of claim 1, wherein the application delivery controller agents are adapted to send responses from the application servers to the client device by bypassing the application delivery controller.

8. The system of claim 7, wherein the application delivery controller agents are adapted to determine whether to close a connection and send a message regarding the closing of the connection to the associated client device and the application delivery controller if a connection should be closed.

9. The system of claim 1, wherein the application delivery controller agents are adapted to determine if a connection request should be redirected to another application delivery controller agent and initiate a redirection of the connection request to the other application delivery controller agent if a connection request should be redirected to another application delivery controller agent.

10. The system of claim 1, wherein the application delivery controller agents are virtual machines that may be replicated as message traffic for the application delivery controller increases.

11. A method comprising:
receiving a connection request at an application delivery controller from a client device;
analyzing the connection request to determine one of a plurality of application delivery controller agents to handle the connection request; and
sending the connection request to the determined application delivery controller agent; and
analyzing the connection at the determined application delivery controller agent request to determine an application server to handle the connection request.

12. The method of claim 11, wherein determining an application delivery controller agent to handle the connection request comprises analyzing routing data associated with the connection request, and determining an application server to handle the connection request comprises analyzing the payload contents of the connection request.

13. The method of claim 11, further comprising analyzing a connection request to determine whether the application delivery controller will handle the connection request without the assistance of the application delivery controller agents.

14. The method of claim 11, further comprising:
sending the address for a client device associated with a connection request from the application delivery controller to the handling application delivery controller agent; and
using the client device address at the handling application delivery controller agent as the source address when providing connection request to the determined application server.

15. The method of claim 14, further comprising:
sending the address for a client device associated with a response to a connection request from the handling application delivery controller agent to the application delivery controller; and
using the client device address in sending the response from the application delivery controller to the client device.

16. The method of claim 11, further comprising sending an application server response from an application delivery controller to a client device by bypassing the application delivery controller.

17. The method of claim 16, further comprising:
determining whether to close a connection at an application delivery controller agent; and
sending a message regarding the closing of the connection to the associated client device and the application delivery controller if a connection should be closed.

18. The method of claim 11, further comprising:
determining at an application delivery controller agent if a connection request should be redirected to another application delivery controller agent; and
initiating the redirection of the connection request to the other application delivery controller agent if the connection request should be redirected to another application delivery controller agent.

19. The method of claim 11, further comprising replicating the application delivery controller agents as message traffic for the application delivery controller increases.
